(19) United States
(12) Patent Application Publication
(10) Pub. No.: US 2025/0370096 A1
(43) Pub. Date: Dec. 4, 2025

(54) AXIAL DISPLACEMENT ESTIMATION APPARATUS

(71) Applicant: DENSO CORPORATION, Kariya-city (JP)

(72) Inventors: Katsuhiko KONDO, Nisshin-city (JP); Koichi SATO, Kariya-city (JP)

(21) Appl. No.: 19/299,122

(22) Filed: Aug. 13, 2025

Related U.S. Application Data
(63) Continuation of application No. PCT/JP2024/005505, filed on Feb. 16, 2024.

(30) Foreign Application Priority Data
Feb. 20, 2023 (JP) 2023-024391

(51) Int. Cl. G01S 7/40; G01S 13/42; G01S 13/931

(52) U.S. Cl. CPC G01S 7/4034; G01S 13/42; G01S 13/931

(57) ABSTRACT

An estimation apparatus extracts first observation point as a first roadside object observation point, where radar waves are reflected at roadside objects in a lateral side of a traveling road where the mobile body travels, the roadside objects being arranged at a position higher than the traveling road along a direction where the traveling road extends. The estimation apparatus extracts a second roadside object observation point as a second observation point corresponding to first roadside object observation point, based on a predetermined association condition. The estimation apparatus calculates direction information indicating a direction along which the roadside object extends, based on a distribution of locations of an extracted plurality of the second roadside object observation points, thereby calculating an angle indicating an inclination of a center axis of the radar apparatus with respect to a longitudinal direction of a mobile body to be an axial displacement angle.

### Cross-Reference of Related Applications

This application is the U.S. bypass application of International Application No. PCT/JP2024/005505 filed on Feb. 16, 2024 which designated the U.S. and claims priority to Japanese Patent Application. 2023-024391 filed on Feb. 20, 2023, the contents of both of these are incorporated herein by reference.

### BACKGROUND

### Technical Field The present disclosure relates to an axial displacement estimation apparatus that estimates an axial displacement angle of a radar apparatus.

### Description of the Related Art

A patent literature discloses an axial displacement estimation apparatus that emits radar waves towards roadside objects arranged in a lateral side of a traveling road where a mobile body travels along a direction extending in the traveling road, to acquire information of a plurality roadside objects from a radar apparatus, thereby estimating an axial displacement angle of the radar apparatus based on the information of the roadside objects information.

### SUMMARY

One aspect of the present disclosure is an axial displacement estimation apparatus that estimates an axial displacement angle of a radar apparatus mounted on a mobile body and is provided with a first roadside object extraction unit, a second roadside object extraction unit and an axial displacement angle calculation unit.

### BRIEF DESCRIPTION OF THE DRAWINGS

FIG. 1 is a block diagram showing a configuration of an axial displacement detection system.

FIG. 2 is a diagram showing a modulation of radar waves.

FIG. 3 is a diagram showing a maximum detection distance for first and second modulations.

FIG. 4 is a diagram showing a configuration for first and second array antennas.

FIG. 5 is a flowchart showing an axial displacement adjustment process.

FIG. 6 is a flowchart showing a roadside object candidate point extraction process.

FIG. 7 is a flowchart showing a roadside object point group extraction process

FIG. 8 is a diagram showing a method for extracting a roadside object point group.

FIG. 9 is a flowchart showing a roadside object point group association process.

FIG. 10 is a flowchart showing an axial displacement angle estimation process according to a first embodiment.

FIG. 11 is a diagram showing an approximate straight line and a vertical axial displacement angle.

FIG. 12 is a diagram showing a positional variation of an observation point between the first modulation and the second modulation.

FIG. 13 is a flowchart showing an axial displacement angle estimation process according to a second embodiment.

FIG. 14 is a diagram showing a method for calculating the approximate straight line in the second embodiment.

FIG. 15 is a flowchart showing an axial displacement angle estimation process according to a third embodiment.

### DETAILED DESCRIPTION OF THE PREFERRED EMBODIMENTS

JP-A-2021-148561 discloses an axial displacement estimation apparatus that emits radar waves towards roadside objects arranged in a lateral side of a traveling road where a mobile body travels along a direction extending in the traveling road, to acquire information of a plurality roadside objects from a radar apparatus, thereby estimating an axial displacement angle of the radar apparatus based on the information of the roadside objects information.

As a result of detailed research of the inventors, a problem arises that an estimation accuracy of the axial displacement of the radar apparatus is required to be improved in order to improve the object detection accuracy of the radar apparatus.

### First Embodiment

Hereinafter, with reference to the drawings, a first embodiment of the present disclosure will be described.

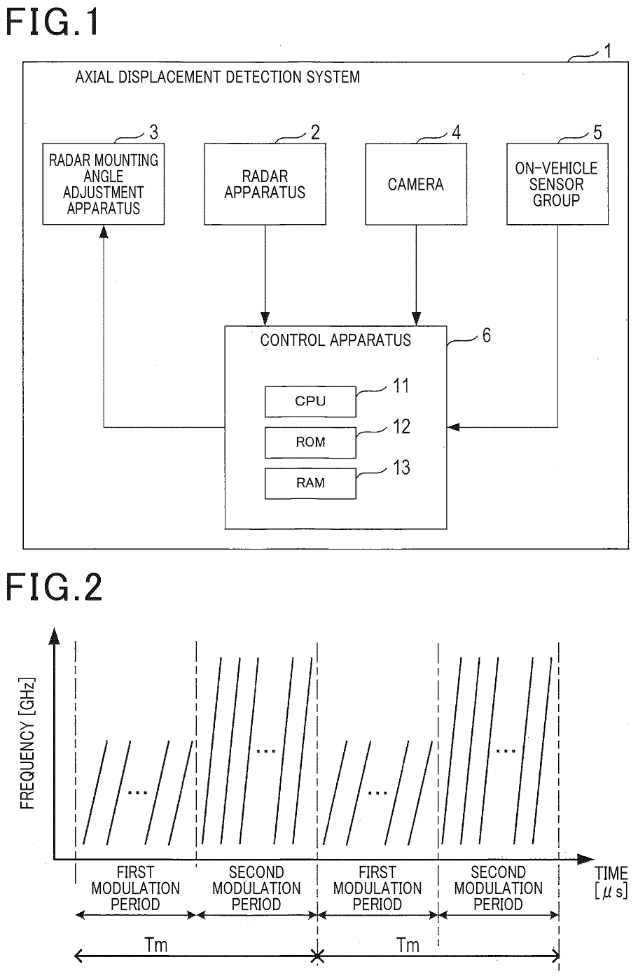

As shown in FIG. 1, an axial displacement detection system 1 according to the present embodiment is provided with a radar apparatus 2, a radar mounting angle adjustment apparatus 3, a camera 4, an on-vehicle sensor group 5 and a control apparatus 6.

The radar apparatus 2 is configured as a MIMO radar which simultaneously transmits and receives electromagnetic waves using a plurality of antennas. MIMO is an abbreviation of Multiple Input Multiple Output.

The radar apparatus 2 is mounted to a front lateral left surface of a vehicle (hereinafter referred to as own vehicle) on which the axial displacement detection system 1 is mounted. The radar apparatus 2 may be mounted to a front lateral right surface of the own vehicle or may be mounted to a rear lateral left side surface or may be mounted to a front side of the own vehicle or may be mounted to a rear side of the own vehicle.

The radar apparatus 2 is arranged to include, in its detection region, a front direction region along a straight-advancing direction of the own vehicle and a lateral direction region orthogonal to the straight-advancing direction.

The radar mounting angle adjustment apparatus 3 is provided with a motor, a gear attached to the radar apparatus 2. The radar mounting angle adjustment apparatus 3 causes the motor to rotate in accordance with a drive signal outputted by the control apparatus 6, whereby the rotational force is transmitted to the gear, causing the radar apparatus 2 to rotate around an axis along a vehicle width direction of the own vehicle.

The camera 4 is mounted to a front side of the own vehicle and continuously captures the front side region of the own vehicle.

The on-vehicle sensor group 5 is configured of a plurality of sensors mounted on the own vehicle to detect the state of the own vehicle. The on-vehicle sensor group 5 includes a vehicle speed sensor that detects a traveling speed of the own vehicle. The on-vehicle sensor group 5 includes an acceleration sensor that detects an acceleration of the own vehicle. The on-vehicle sensor group 5 includes a yaw rate sensor that detects a yaw rate of the own vehicle.

The control apparatus 6 is an electronic control apparatus configured mainly of a microcomputer provided with a CPU 11, a ROM12, a RAM 13 and the like. Note that various functions of the microcomputer is accomplished by the CPU 11 when executing programs stored in a non-transitory substantial recording media. According to this example, the ROM12 corresponds to the non-transitory substantial recording media storing the programs. Also, with an execution of the programs, a method corresponding to the programs is executed. Note that, a part of or all of functions executed by the CPU 11 may be configured of one or more ICs as hardware circuit. The number of microcomputers that constitute the control apparatus 6 may be one or more numbers.

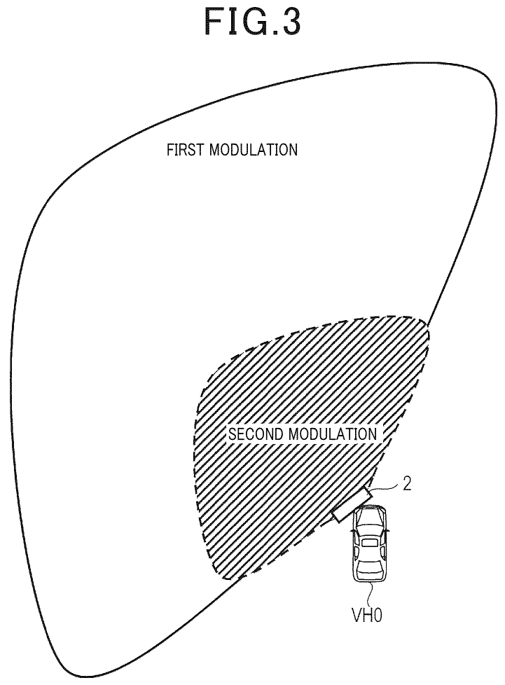

As shown in FIG. 2, the radar apparatus 2 switches between a first modulation period and a second modulation period within a predetermined modulation cycle Tm. In the first modulation period, a first high-frequency signal is generated, which is composed of a plurality of first chirp signals of which the frequency linearly increases. In the second modulation period, a second high-frequency signal is generated, which is composed of a plurality of second chirp signals of which the frequency linearly increases. Then, the radar apparatus 2 emits the generated first and second high frequency signals as first and second radar waves and receives reflected first and second radar waves. According to the present embodiment, frequency width of the first chirp signal is narrower than the frequency width of the second chirp signal.

As shown in FIG. 3, the radar apparatus 2 is configured such that the maximum detection distance (hereinafter referred to as first maximum detection distance) of a modulation (hereinafter referred to as first modulation) in the first modulation period, is set to be longer than the maximum detection distance (hereinafter referred to as second maximum detection distance) of a modulation (hereinafter referred to as second modulation) in the second modulation period.

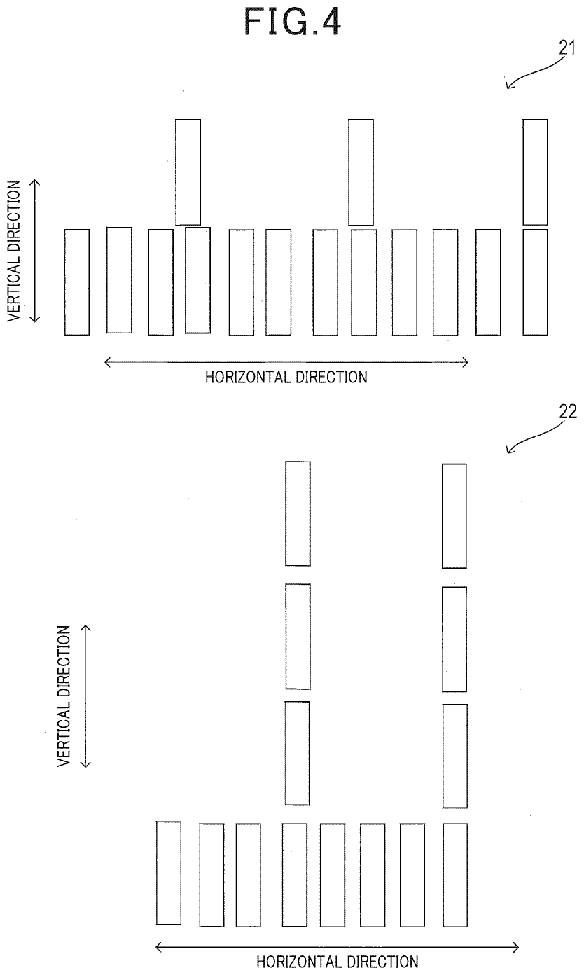

As shown in FIG. 4, the radar apparatus 2 is provided with a first array antenna 21 and a second array antenna 22.

The first array antenna 21 is configured such that 12 antennas having the same characteristics are arranged along a horizontal direction (i.e. vehicle width direction) at the same intervals and 2 antennas having the same characteristics are arranged along the vertical direction (i.e. vehicle height direction) at the same intervals.

The second array antenna 22 is configured such that 8 antennas having the same characteristics are arranged along a horizontal direction (i.e. vehicle width direction) at the same intervals and 4 antennas having the same characteristics are arranged along the vertical direction (i.e. vehicle height direction) at the same intervals. The radar apparatus 2 transmits and receives, in the first modulation period, the first radar waves using the first array antenna 21, and transmits and receives, in the second modulation period, the second radar waves using the second array antenna 22.

Hence, a vertical measurement angle accuracy in the second modulation (hereinafter referred to as second vertical measurement angle accuracy) is higher than a vertical measurement angle accuracy in the first modulation (hereinafter referred to as first vertical measurement angle accuracy). Also, a horizontal measurement angle accuracy in the first modulation is higher than a horizontal measurement angle accuracy in the second modulation.

The radar apparatus 2 detects, for each first modulation period and second modulation period, a reception power W of the received radar waves, a distance R to a location (hereinafter referred to as observation point) at which the radar waves are reflected, a relative speed V relative to the observation point, a horizontal azimuth angle θ of the observation point and a vertical azimuth angle φ. Then the radar apparatus 2 outputs observation information indicating the detected reception power W, distance R, relative speed V, horizontal azimuth angle θ and vertical azimuth angle to the control apparatus 6. Hereinafter, a location at which the first radar waves are reflected is referred to as first modulation observation point, a location at which the second radar waves are reflected is referred to as second modulation observation point. The observation information acquired in the first modulation is referred to as first modulation observation point information, and the observation information acquired in the second modulation is referred to as second modulation observation point information.

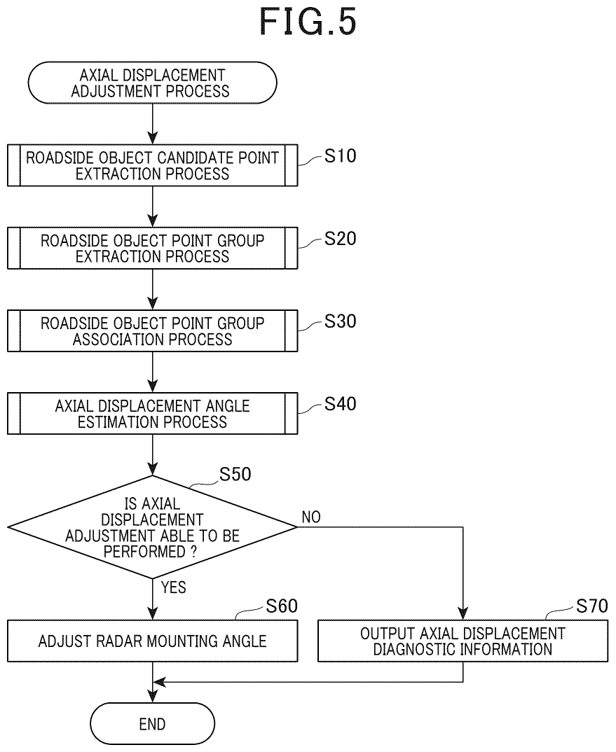

Next, a procedure of an axis displacement adjustment process executed by the control apparatus 6 will be described. The axial displacement adjustment process is repeatedly executed every time when the modulation cycle Tm elapses during an operation of the control apparatus 6. When the axial displacement adjustment process is executed, the CPU 11 of the control apparatus 6 executes, as shown in FIG. 5, a roadside object candidate point extraction process (hereinafter referred to as object candidate extraction process) at step S10 which will be described later. The roadside object candidate point extraction process is for extracting, from among a plurality of pieces of first modulation observation point information acquired from the radar apparatus 2, roadside object candidate points as candidates of the roadside object.

The CPU 11 executes a roadside object point group extraction process at step S20 which will be described later. The roadside object point group extraction process is for extracting, from among a plurality of roadside object candidates extracted at step S10, point group (hereinafter referred to as roadside object point group) that constitutes the roadside object.

The CPU 11 executes a roadside object point group association process at step S30 which will be described later. The roadside object point group association process is a process for association the roadside object point group extracted at step S30 with the second modulation observation point.

The CPU 11 executes an axial displacement angle estimation process at step S40 which will be described later. The axial displacement angle estimation process is for calculating the vertical axial displacement angle Om of the radar apparatus 2 based on the second modulation observation point associated at step S40.

The CPU 11 determines, at step S50, whether the radar mounting angle adjustment apparatus 3 is able to adjust an axial displacement. Specifically, the CPU 11 determines whether the vertical axial displacement angle θm calculated at step S40 is lower than or equal to a predetermined adjustable angle, and determines that the axial displacement can be adjusted when determined that the vertical axial displacement angle Om is lower than or equal to the predetermined adjustable angle.

In the case where the axial displacement angle can be adjusted, the CPU 11 controls, at step S60, the radar mounting angle adjustment apparatus 3 to cause the radar apparatus 2 to rotate around the axis along the vehicle width direction of the own vehicle for an axial displace angle θm, thereby adjusting the radar mounting angle such that the center axis CA of the radar apparatus 2 corresponds to the longitudinal direction of the own vehicle. Then, the axial displacement adjusting process is terminated.

On the other hand, in the case where the axial displacement cannot be adjusted, the CPU 11 outputs, at step S70, diagnostic information indicating that the center axis CA of the radar apparatus 2 is misaligned, outside the control apparatus 6 and terminates the axial displacement adjustment process.

Next, procedure of an object candidate extraction process executed by step S10 will be described.

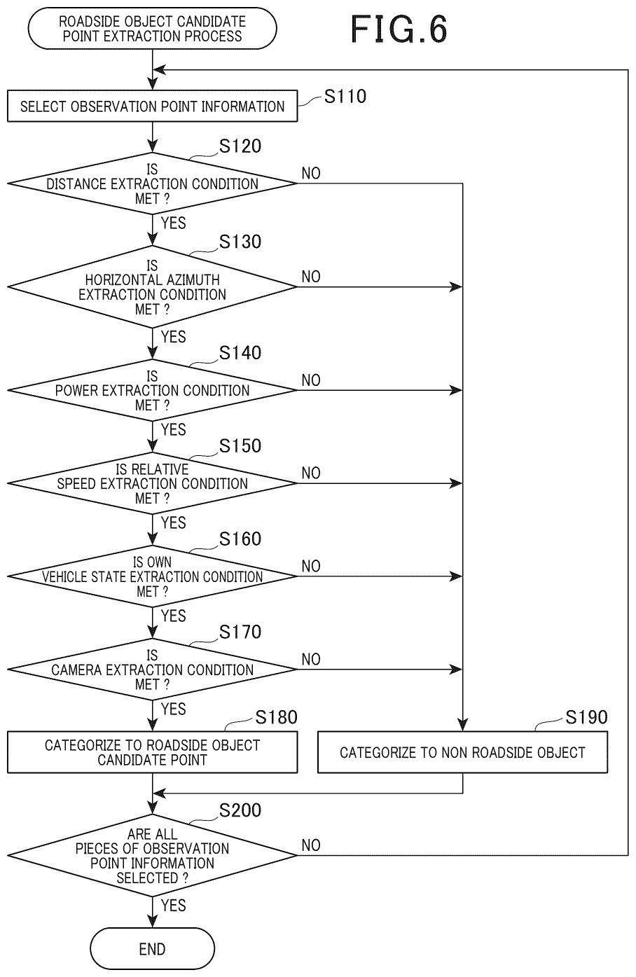

When the object candidate extraction process is executed, as shown in FIG. 6, the CPU 11 selects at step S110, from among a plurality of pieces of first modulation observation point information which are newly acquired during a period from the previous object candidate extraction process to the current object candidate extraction process, one piece of first modulation observation point information which is not selected in the current object candidate extraction process.

The CPU 11 determines, for the first modulation observation point information (hereinafter referred to as selected observation point information) selected at step S110, whether a predetermined distance extraction condition is met. The distance extraction condition according to the present embodiment refers to a condition in which a distance R of the selected observation point information is larger than or equal to a predetermined first distance threshold and smaller than a predetermined second distance threshold. According to the present embodiment, the first distance threshold is 2 m, for example and the second distance threshold is 100 m, for example.

Here, when the distance extraction condition is not met, the CPU 11 proceeds to step S190. On the other hand, when the distance extraction condition is met, the CPU 11 determines, at step S130, whether a predetermined horizontal direction extraction condition is met for the selected observation point information. The horizontal direction extraction condition according to the present embodiment is a condition in which the horizontal azimuth angle θ of the selected observation point information is larger than or equal to a predetermined first horizontal azimuth angle threshold and smaller than a predetermined second horizontal azimuth angle threshold

Here, when the horizontal azimuth extraction condition is not met, the CPU 11 proceeds to step S190. On the other hand, when the horizontal azimuth extraction condition is met, the CPU 11 determines, at step S140, whether a predetermined power extraction condition is met for the selected observation point information. The power extraction condition according to the present embodiment refers to a condition in which the reception power W of the selected observation point information is higher than or equal to a predetermined first power threshold and lower than a predetermined second power threshold.

Here, when the power extraction condition is not met, the CPU 11 proceeds to step S190. On the other hand, when the power extraction condition is met, the CPU 11 determines, at step S150, whether a predetermined relative speed extraction condition is met for the selected observation point information. The relative speed extraction condition according to the present embodiment is a condition in which a difference between an absolute value of the relative speed V of the selected observation point information and an absolute value of a traveling speed detected by the vehicle speed sensor included in the on-vehicle sensor group 5 is less than a predetermined relative speed threshold. Note that the relative speed threshold is set such that the difference between an absolute value of the relative speed V and an absolute value of a traveling speed detected by the vehicle speed sensor indicates sufficiently small.

In the case where the relative speed extraction condition is not met, the CPU 11 proceeds to step S190. On the other hand, when the relative speed extraction condition is met, the CPU 11 determines, at step S160, whether a predetermined own vehicle state extraction condition is met for the selected observation point information. The own vehicle state extraction condition according to the present embodiment is met when both a predetermined acceleration extraction condition and a predetermined yaw rate extraction condition are met. The acceleration extraction condition according to the present embodiment is a condition in which the acceleration detected by the acceleration sensor included in the on-vehicle sensor group 5 is less than a predetermined acceleration threshold. The yaw rate extraction condition according to the present embodiment is a condition in which a yaw rate detected by the yaw rate sensor included in the on-vehicle sensor group 5 is less than a predetermined yaw rate threshold. In other words, the own vehicle state extraction condition is that the own vehicle is traveling straight at a constant traveling speed.

When the own vehicle state extraction condition is not met, the CPU 11 proceeds to step S190. On the other hand, when the own vehicle state extraction condition is met, the CPU 11 determines, at step S170, whether a predetermined camera extraction condition is met for the selected observation point information. The camera extraction condition according to the present embodiment is a condition in which a roadside object is present, in the image captured by the camera 4, at a location corresponding to the selected observation point information. The CPU 11 executes a known image processing for the image captured by the camera 4, thereby identifying a roadside object existing in the image captured by the camera 4.

When the camera extraction condition is not met, the CPU 11 proceeds to step S190. On the other hand, when the camera extraction condition is met, the CPU 11 categorizes, at step S180, the selected observation point information to be ‘roadside object candidate point, and proceeds to step S200.

When proceeded to step S190, the CPU 11 categorizes the selected observation point information to be ‘non-roadside object’ and proceeds to step S200.

When proceeded to step S200, the CPU 11 determines whether all pieces of newly acquired first modulation observation point information are selected at step S110. Here, in the case where all of pieces of first modulation observation point information are not selected, the CPU 11 proceeds to step S110. On the other hand, in the case where all of pieces of first modulation observation point information are selected, the CPU 11 terminates the object candidate extraction process.

Next, a roadside object point group extraction process executed at step $20 will be described.

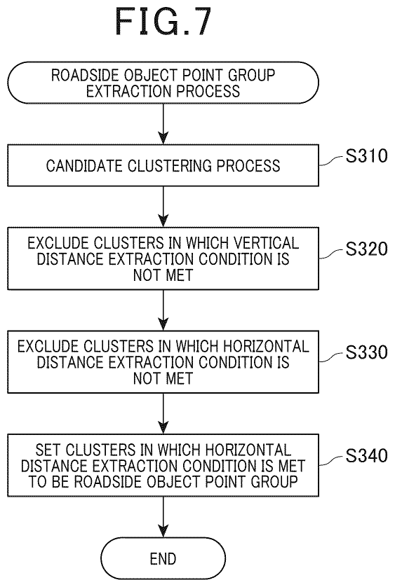

When the roadside object point group extraction process is executed, as shown in FIG. 7, the CPU 11 executes, at step S310, a candidate clustering process that divides a plurality of roadside candidate points into clusters. Specifically, the CPU 11 divides, based on locations of the roadside candidate points, the plurality of roadside candidate points into a plurality of clusters (e.g. 6 clusters) using a known k-means method, for example.

The CPU 11 determines, at step S320, whether a predetermined vertical distance extraction condition is met for respective clusters generated at step S310, and excludes clusters in which the vertical distance extraction condition is not met. The vertical distance extraction condition according to the present embodiment is that the cluster has a length longer than or equal to a predetermined vertical distance threshold set in advance along the traveling direction of the own vehicle. According to the present embodiment, the vertical distance threshold is 40 meters for example. Specifically, the CPU 11 determines that the vertical distance extraction condition is met in the case where a difference between a distance R of an observation point information for a roadside object candidate point which is the farthest from the own vehicle along the traveling direction among a plurality of roadside object candidate points constituting the cluster, and a distance R of the observation point information for a roadside object candidate point which is the closest to the own vehicle along the traveling direction among a plurality of roadside object candidate points constituting the cluster, is larger than or equal to the vertical distance threshold.

The CPU 11 determines, at step S330, whether a predetermined horizontal distance extraction condition is met for the clusters which are not excluded at step S320, and excludes clusters in which the horizontal distance extraction condition is not met. The horizontal distance extraction condition according to the present embodiment is that the cluster has a length less than a predetermined horizontal distance threshold set in advance along a vehicle width direction of the own vehicle. According to the present embodiment, the horizontal distance threshold is 1 meter for example. Specifically, the CPU 11 determines that the horizontal distance extraction condition is met in the case where a difference between a distance R of an observation point information for a roadside object candidate point which is the farthest from the own vehicle along the vehicle width direction among a plurality of roadside object candidate points constituting the cluster, and a distance R of the observation point information for a roadside object candidate point which is the closest to the own vehicle along the vehicle width direction among a plurality of roadside object candidate points constituting the cluster, is less than the horizontal distance threshold.

The CPU 11 determines, at step S340, whether a predetermined lateral location extraction condition is met for clusters which are not excluded at steps S320 and S330, sets the clusters in which the lateral location extraction condition is met to be ‘roadside object point group’ and terminates the roadside object point group extraction process. The lateral location extraction condition according to the present embodiment is that it is located at the most inner side in a left side of the own vehicle.

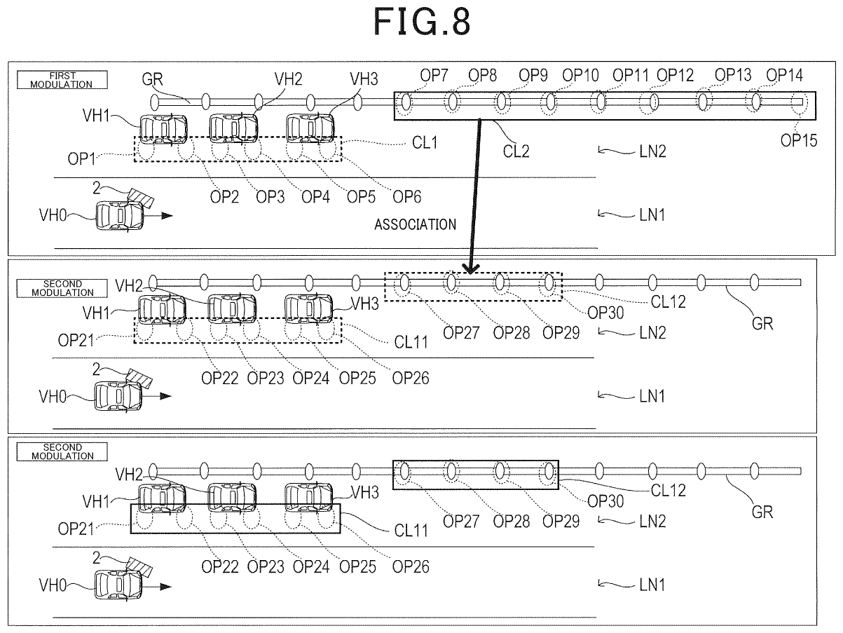

As shown in FIG. 8, it is assumed that the own vehicle VH0 is traveling on a passing lane LN1 in two lanes road on each side, three vehicles VH1, VH2 and VH3 are travelling linearly along a traveling direction on a traveling lane LN2 in the front left side of the own vehicle VH0, and a guard rail GR is provided on a left side of the traveling lane LN2.

Then, the radar apparatus 2 mounted on the own vehicle VH0 transmits and receives radar waves modulated as a first modulation (i.e. above-described first radar waves) whereby observation points OP1, OP2, OP3, OP4, OP5, OP6, OP7, OP8, OP9, OP10, OP11, OP12, OP13, OP14 and OP15 are detected in the order closer to the radar apparatus 2.

The observation point OP1 is a point at which the first radar waves are reflected in the rear right side of the vehicle VH1. The observation point OP2 is a point at which the first radar waves are reflected in the front right side of the vehicle VH1.

The observation point OP3 is a point at which the first radar waves are reflected in the rear right side of the vehicle VH2. The observation point OP4 is a point at which the first radar waves are reflected in the front right side of the vehicle VH2.

The observation point OP5 is a point at which the first radar waves are reflected in the rear right side of the vehicle VH3. The observation point OP6 is a point at which the first radar waves are reflected in the front right side of the vehicle VH3.

The observation points OP7 to OP15 are points on the guard rail GR at which the first radar waves are reflected.

With the above-describe candidate clustering process, a cluster CL1 including the observation points OP1 to OP6 and a cluster CL2 including the observation points OP7 to OP15 are generated.

Since the length of the cluster CL1 along the traveling direction of the own vehicle is short, the vertical distance extraction condition is not met, and thus the cluster 1 is excluded in the process at step S320. Since the length of the cluster CL2 along the traveling direction of the own vehicle is long, the vertical distance extraction condition is met, and thus the cluster 2 is not excluded in the process at step S320. Then, the cluster CL2 is set as a roadside object point group. In FIG. 8, a rectangular area indicated by a solid line shows a cluster being set as roadside object group, and a rectangular area indicated by a dotted line shows a cluster not being set as roadside object group.

Also, it is assumed that the radar apparatus 2 mounted on the own vehicle VH0 transmits and receives radar waves modulated as a second modulation (i.e. the above-described second radar apparatus), whereby observation points OP21,OP22, OP23, OP24, OP25, OP26, OP27, OP28, OP29, OP30 are detected in the order closer to the radar apparatus 2. The maximum detection distance of the second modulation is shorter than the maximum detection distance. Hence, the radar apparatus 2 cannot detect observation point located farther than the observation point OP30 in the second modulation.

The observation point OP21 is a point at which the second radar waves are reflected in the rear right side of the vehicle VH1. The observation point OP22 is a point at which the second radar waves are reflected in the front right side of the vehicle VH1.

The observation point OP23 is a point at which the second radar waves are reflected in the rear right side of the vehicle VH2. The observation point OP24 is a point at which the second radar waves are reflected in the front right side of the vehicle VH2.

The observation point OP25 is a point at which the second radar waves are reflected in the rear right side of the vehicle VH3. The observation point OP26 is a point at which the second radar waves are reflected in the front right side of the vehicle VH3.

The observation points OP27 to OP30 are points on the guard rail GR at which the second radar waves are reflected.

With the above-described candidate clustering process, the cluster CL21 including the observation points OP21 to OP26 and the cluster CL12 including the observation points OP27 to OP30 are generated.

Since the length of the cluster CL11 along the traveling direction of the own vehicle is short, the vertical distance extraction condition is not met, and thus the cluster 11 is excluded in the process at step S320. Also, since the length of the cluster CL12 along the traveling direction of the own vehicle is short, the vertical distance extraction condition is not met regardless of the observation points corresponding to a reflection at the guard rail GR, and thus the cluster 12 is excluded in the process at step S320.

Hence, similar to the cluster CL12 which is set to be ‘roadside object point group’, when the vertical distance threshold in the vertical distance extraction condition is set to be smaller, the cluster 11 composed of observation points at which radar waves are reflected at the vehicles VH1, VH2 and VH3 are also set to be ‘roadside object point group’. FIG. 8 illustrates a case where the clusters CL11 and CL12 indicated by a rectangular with a solid line are set to be ‘roadside object point group’.

Hence, in order to set the clusters composed of observation points with a reflection at the guard rail to be ‘roadside object point group’, the first modulation not the second modulation is required.

Next, a roadside object point group association process executed at step S30 will be described.

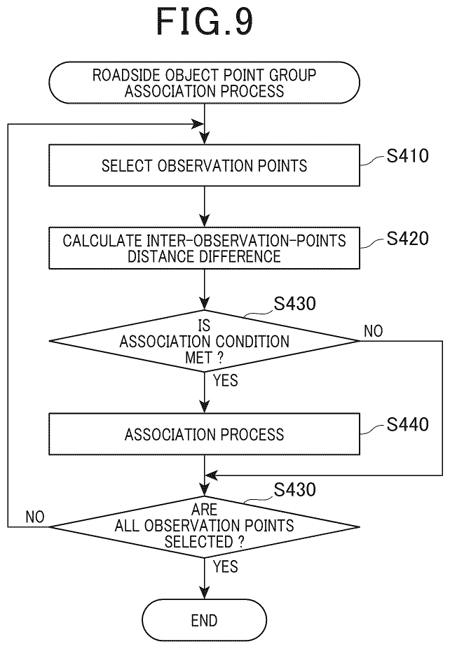

When the roadside object point group association process is executed, as shown in FIG. 9, the CPU 11 selects, at step S410, one observation point which is not selected in the current roadside object point group association process, among observation points included in the clusters (hereinafter referred to as set-cluster) set as a roadside object point group at step S340.

The CPU 11 calculates, at step S420, a distance (hereinafter referred to as inter-observation-points distance difference) between the first modulation observation point selected at step S410 (hereafter referred to as selected observation point) and each of the second modulation observation points detected in the second modulation period in the same modulation cycle Tm.

For example, in the case where the observation point OP7 shown in FIG. 8 is a selected observation point, the CPU 11 calculates a distance between the observation point OP7 and each of the observation points OP21 to OP30 detected in the second modulation, to be an inter-observation-points distance difference.

The CPU 11 determines, at step S430, whether a predetermined association condition is met for each of the inter-observation-points distance differences calculated at step S420. The association condition of the present embodiment is a condition in which the inter-observation-points distance difference is the minimum and the inter-observation-points distance difference is less than a predetermined association threshold.

In the case where inter-observation-points distance difference which satisfies the association condition is not present, the CPU 11 proceeds to step S450. On the other hand, in the case where the inter-observation-points distance difference that satisfies the association condition is present, at step S440, the CPU 11 associates the second modulation observation point corresponding to the inter-observation-points distance difference in which the association condition is met, with the selected observation point (i.e. first modulation observation point), and stores the second modulation observation information of the second modulation observation points which are caused to be associated with the selected observation point, into the RAM13, and proceeds to step S450. For example, the observation points OP7, OP8, OP9 and OP10 shown in FIG. 8 are caused to be associated with the observation points OP27, OP28, OP29 and OP30, respectively.

When the process proceeds to step S450, the CPU 11 determines whether all of the first modulation observation points included in the set-cluster are selected at step S410. Here, in the case where some observation points have not yet been selected, the CPU 11 proceeds to step S410. On the other hand, in the case where all of the first modulation observation points are selected, the CPU 11 terminates the roadside object point group association process.

Next, an axial displacement angle estimation process executed at step S40 will be described.

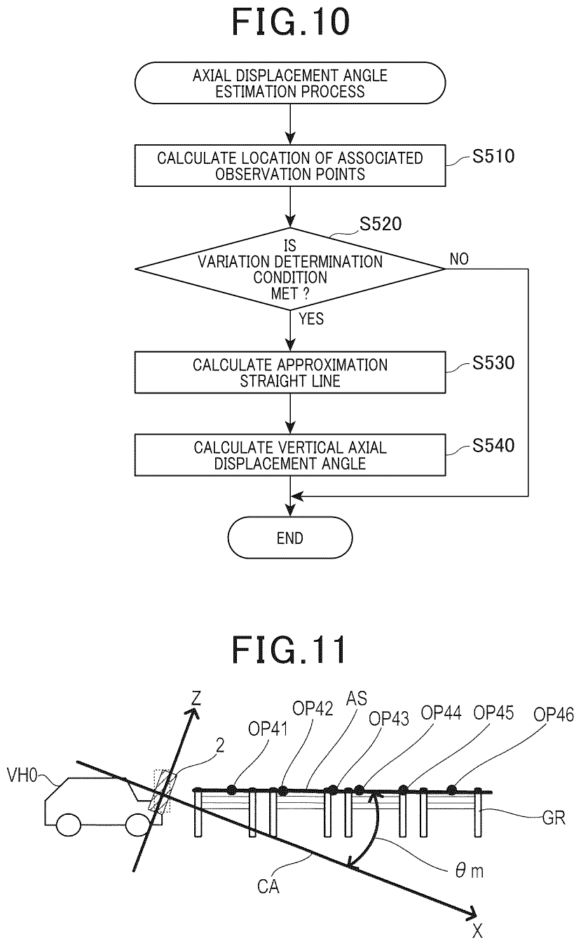

When the axial displacement angle estimation process is executed, as shown in FIG. 10, at step S510, the CPU 11 calculates, for each of the second modulation observation points (hereinafter referred to as associated observation point) which are associated with the first modulation observation points at step S450, locations (x, y, z) of the associated observation points, based on a distance R, a horizontal azimuth angle θ and a vertical azimuth angle o included in the second modulation observation point information of the associated observation points. The locations (x, y, z) are defined in a three-dimensional orthogonal coordinate system of which the origin is the radar apparatus 2. As shown in FIG. 11, the X axis in the three-dimensional orthogonal coordinate system coincides with the center axis CA in transmission and reception of radar waves in the radar apparatus 2. Moreover, the Y axis in the three-dimensional orthogonal coordinate system is set to be orthogonal to the X axis along the vehicle width direction of the own vehicle VH0.

The Z axis in the three-dimensional orthogonal coordinate system is set to be orthogonal to the X axis and the Y axis.

As shown in FIG. 10, the CPU 11 determines, at step S520, whether a predetermined variation determination condition is met, indicating that variation in the locations of all associated observation points is small. The variation determination condition is for determining whether a plurality of associated observation points vary in the Z-X plane in the above-described three-dimensional orthogonal coordinate system, causing a difficulty for calculating an approximate straight line AS at step S530 (described later). As a variation condition, for example, a correlation function between a plurality of associated observation points in the Z-Y plane can be adopted.

Here, when the variation determination condition is not met, the CPU 11 terminates the axial displacement angle estimation process. On the other hand, when the variation determination condition is met, the CPU 11 utilizes locations (x, y, z) of all associated observation points to calculate the approximate straight line AS using least square method.

As shown in FIG. 11, the approximate straight line AS passes through a region on the Z-X plane in the above-described three-dimensional orthogonal coordinate system and expressed as the following equation (1). In the equation (1), β indicates an inclination, C indicates an intercept. FIG. 11 shows an approximate straight line calculated using the locations (x, y, z) of the associated observation points OP41, OP42, OP43, OP44, OP45, OP46 at which the radar waves are reflected on the guard rail GR.

$$Z = β \cdot X + C \qquad ( 1 )$$

As shown in FIG. 10, the CPU 11 calculates, at step S540, an angle corresponding to the inclination β of the approximation straight line AS, sets positive or negative signs of the angle to be opposite, thereby calculating the vertical axial displacement angle θm, and terminates the axial displacement angle estimation process.

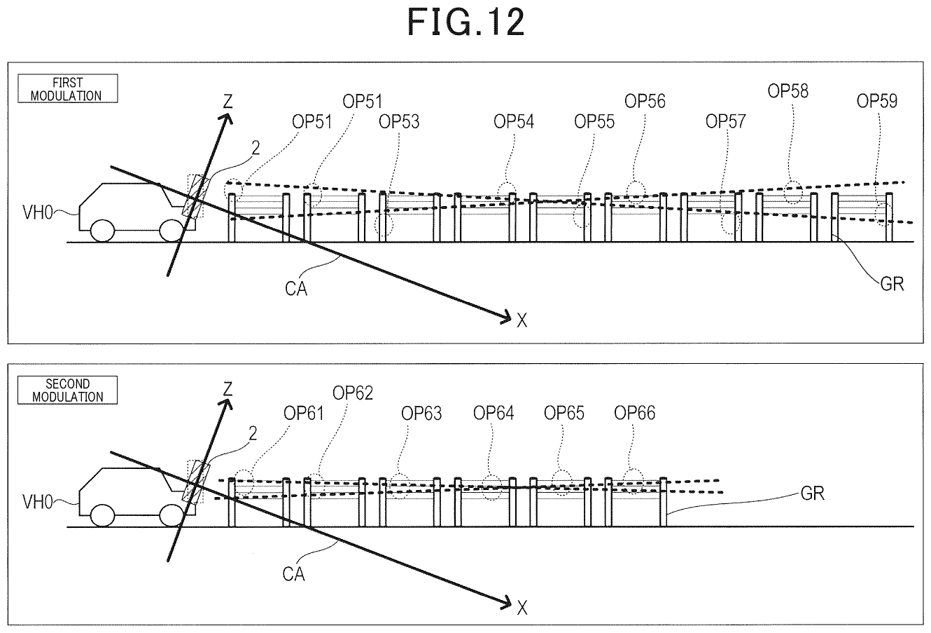

As shown in FIG. 12, it is assumed that the radar apparatus 2 mounted on the own vehicle VH0 transmits and receives radar waves modulated as a first modulation (i.e. the above-described first radar waves), whereby the observation points OP51, OP52, OP53, OP54, OP55, OP56, OP57, OP58 and OP59 where the radar waves are reflected at the guard rail GR are detected in the order closer to the radar apparatus 2.

Moreover, it is assumed that the radar apparatus 2 transmits and receives radar waves modulated as a second modulation (i.e. the above-described second radar waves), whereby the observation points OP61, OP62, OP63, OP64, OP65, OP66, OP67, OP68 and OP69 where the radar waves are reflected at the guard rail GR are detected in the order closer to the radar apparatus 2.

As described above, the vertical measurement angle accuracy in the second modulation is higher than that of the first modulation. Hence, a variation in the locations of the observation points OP61 to OP66 modulated as a second modulation is lower than that of the observation points OP61 to OP59 in the first modulation.

Accordingly, the vertical axial displacement angle Om acquired by calculating the approximate straight line AS using the second modulated observation points OP61 to OP66 has an estimation accuracy higher than the vertical axial displacement angle θm acquired by calculating the approximate straight line AS using the first modulated observation points OP61 to OP59.

The control apparatus 6 thus configured estimates the vertical axial displacement angle θm of the radar apparatus 2 mounted on the own vehicle VH0.

The radar apparatus 2 is configured to transmit and receive the first radar waves modulated using a first modulation method to detect a first modulated observation point as a point at which the first radar waves are reflected, thereby repeatedly outputting the first modulation observation point information including a distance R between the radar apparatus 2 and the first modulation observation point (hereinafter referred to as first observation point distance), and a horizontal azimuth angle θ and a vertical azimuth angle φ along which the first modulation observation point is present (hereinafter referred to as first observation point azimuth angle).

The radar apparatus 2 is configured to transmit and receive the second radar waves modulated using a second modulation method to detect a second modulated observation point as a point at which the second radar waves are reflected, thereby repeatedly outputting the second modulation observation point information including a distance R between the radar apparatus 2 and the second modulation observation point (hereinafter referred to as second observation point distance), and a horizontal azimuth angle θ and a vertical azimuth angle q along which the second modulation observation point is present (hereinafter referred to as second observation point azimuth angle).

The control apparatus 6 is configured to extract, among a plurality of first modulation observation points detected by the radar apparatus 2, a first modulation observation point as a roadside object point, where radar waves are reflected at roadside objects in a lateral side of the traveling road where the own vehicle VH0 travels, the roadside objects being arranged at a position higher than the traveling road along a direction where the traveling road extends.

The control apparatus 6 is configured to extract, among a plurality of second modulation observation points detected by the radar apparatus 2, associated observation points as second modulation observation points corresponding to the roadside object points, based on a predetermined association condition indicating that the location of the roadside object point and the location of the second modulation observation point are close.

The control apparatus 6 is configured to calculate an inclination β indicating a direction along which the roadside object extends, based on a distribution of the locations of the plurality of extracted associated observation points, thereby calculating the vertical axial displacement angle Om indicating an inclination of the center axis CA with respect to the longitudinal direction of the own vehicle VH0, the center axis CA indicating a direction of the first and second radar waves being transmitted and received by the radar apparatus 2.

According to the above-described control apparatus 6, a modulation method suitable for detecting roadside objects arranged along a direction where the traveling road extends, is applied to the first modulation method, and a modulation method of which the detection accuracy of the location of the observation point is applied to the second modulation method. Hence, since the inclination B indicating the direction where the roadside object extends can be accurately detected, an estimation accuracy of the vertical axial displacement angle Om can be improved.

Moreover, the first maximum detection distance as a maximum value of the first observation point distance capable of being detected by the first modulation method, is longer than the second maximum detection distance as a maximum value of the second observation point distance capable of being detected by the second modulation method. Then, the second vertical measurement angle accuracy, which is an accuracy for detecting the second observation point azimuth angle in the vertical direction using the second modulation method, is higher than the first vertical measurement angle accuracy, which is an accuracy for detecting the first observation point azimuth angle in the vertical direction using the first modulation method. Thus, the control apparatus 6 can utilize the first modulation method for detecting the roadside objects arranged along a direction where the traveling road extends, and also can utilize the second modulation method for accurately calculating the inclination β.

Moreover, the control apparatus 6 is configured to utilize properties of the roadside object in which the height thereof is constant along a direction where the traveling road extends, to calculate the vertical axial displacement angle θm. Thus, the control apparatus 6 can readily calculate the inclination β.

Also, the control apparatus 6 is configured to approximate a distribution of the locations of the plurality of associated observation points using an approximate straight line, thereby calculating the inclination β. Thus, the control apparatus 6 can readily calculate the inclination β.

In the above-described embodiment, the control apparatus 6 corresponds to axial displacement estimation apparatus, the own vehicle VH0 corresponds to mobile body, the vertical axis displacement angle Om corresponds to axial displacement angle, the first modulation observation point corresponds to first observation point and the second modulation observation point corresponds to second observation point.

Further, steps S10 and S20 correspond to processes of first roadside object extraction unit, the guard rail GR corresponds to roadside object and the roadside object point corresponds to first roadside object observation point, step S30 corresponds to a process of second roadside object extraction unit and the associated observation point corresponds to a second roadside object observation point.

Further, step S40 corresponds to a process of the axial displacement angle calculation unit, and the inclination β corresponds to direction information.

### Second Embodiment

Hereinafter, with reference to the drawings, a second embodiment of the present disclosure will be described. In the second embodiment, configurations different from those in the first embodiment will be described.

In the second embodiment, the same reference numbers as those in the first embodiment are applied to the configurations which are common with those in the first embodiment.

An axial displacement detection system 1 according to the second embodiment differs from the first embodiment in that an axial displacement angle estimation process is changed from the first embodiment.

The axial displacement angle estimation process according to the second embodiment differs from the first embodiment in that process of step S532 is executed instead of executing step S530.

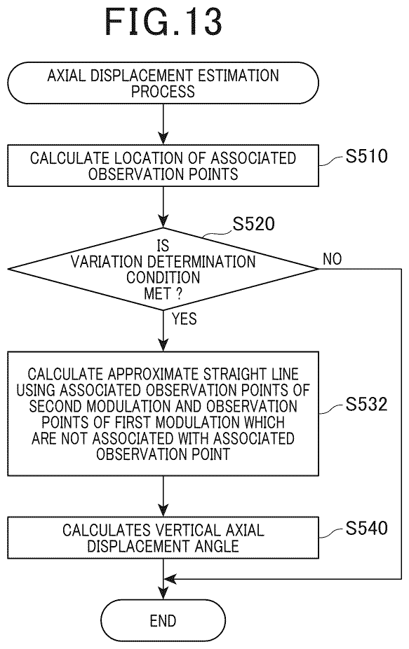

As shown in FIG. 13, when determined that the predetermined variation determination condition is met at step S520, the CPU 11 utilizes, at step S532, locations of all of associated observation points (i.e. observation points of second modulation) and locations of all of observation points which are not associated with associated observation points (i.e. observation point of first modulation) among observation points included in the clusters as the roadside object point group set at step S340 (i.e. set cluster) to calculate the approximate straight line AS using least square method, and proceeds to step S540.

For example, as shown in FIG. 8, the radar apparatus 2 transmits and receives the first modulation radar waves (i.e. the above-described first radar waves), thereby detecting observation points OP7, OP8, OP9, OP10, OP11, OP12, OP13, OP14 and OP15 where the radar waves are reflected at the guard rail GR. Further, the radar apparatus 2 transmits and receives the second modulation radar waves (i.e. the above-described second radar waves), thereby detecting observation points OP27, OP28, OP29 and OP30 where the radar waves are reflected at the guard rail GR.

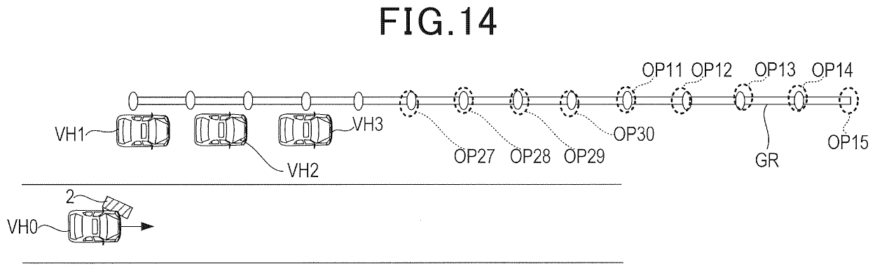

In this case, as shown in FIG. 14, the CPU 11 utilizes the locations of the observation points OP27, OP28, OP29 and OP30, and locations of the observation points OP11, OP12, OP13, OP14 and OP15 to calculate the approximate straight line AS using least square method. The observation points OP27 to OP30 are associated observation points. The observation points OP11 to OP15 are observation points which are not associated with the associated observation points.

The control apparatus6 thus configured utilizes both of the extracted plurality of associated observation points and roadside object points among the extracted plurality of roadside object points which are not associated with the associated observation points, thereby calculating an inclination β. Thus, since the control apparatus 6 is able to increase the number of observation points used for calculating the inclination β, an estimation accuracy of the vertical axial displacement angle Om can be further improved.

### Third Embodiment

Hereinafter, with reference to the drawings, a third embodiment of the present disclosure will be described. In the third embodiment, configurations different from those in the first embodiment will be described. In the third embodiment, the same reference numbers as those in the first embodiment are applied to the configurations which are common with those in the first embodiment.

An axial displacement detection system 1 according to the third embodiment differs from the first embodiment in that an axial displacement angle estimation process is changed from the first embodiment.

The axial displacement angle estimation process according to the third embodiment differs from the first embodiment in that process of steps S514, S524 and S534 are executed instead of executing steps S510, S520 and S530.

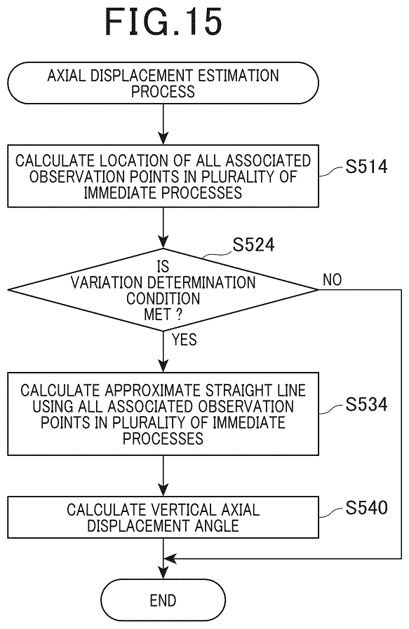

As shown in FIG. 15, when an axial displacement angle estimation process according to the third embodiment is executed, the CPU 11 calculates, at step S514, locations of the associated observation points (x, y, z) for each of the all associated observation points acquired by a plurality of times (e.g. 5 times) of immediate roadside object point group association processes, based on the distance R, the horizontal azimuth angle θ and the vertical azimuth angle o included in the observation point information of the associated observation points.

The CPU 11 determines, at step S514, whether a predetermined variation determination condition is met, indicating that variation of the locations of all of the associated observation points calculated at step S514 is small.

Here, in the case where the variation determination condition is not met, the CPU 11 terminates the axial displacement angle estimation process. On the other hand, in the case where the variation determination condition is met, the CPU 11 utilizes locations (x, y, z) of all of the associated observation points acquired in a plurality of times of immediate roadside object point group association processes, to calculate the approximate straight line AS using least square method and proceeds to step S540.

The control apparatus6 thus configured calculates an inclination β based on a distribution of a plurality of associated observation points acquired during a plurality of modulation cycles Tm, thereby calculating the vertical axis displacement angle θm. Thus, since the control apparatus 6 is able to increase the number of observation points used for calculating the inclination β, an estimation accuracy of the vertical axial displacement angle θm can be further improved.

One embodiment of the present disclosure is described so far. However, the present disclosure is not limited to the above-described embodiments and may be modified in various manners.

### Modification Example 1

According to the above-described embodiments, a configuration in which radar waves modulated in FCM method is exemplified. However, a method executed by the radar apparatus 2 for detecting objects is not limited to the above-described method and any methods may be utilized as long as locations of the objects are detected. Note that FCM is abbreviation of Fast-Chirp Modulation. For example, FMCW method or two frequency continuous wave method may be utilized. FMCW is an abbreviation of Frequency Modulated Continuous Wave. Moreover, a method of transmitting or receiving pulse signals may be utilized.

### Modification Example 2

The above-described embodiments exemplify a configuration in which a vertical axis displacement angle Om is estimated. However, an axial displacement angle in a horizontal direction (i.e. horizontal axis displacement angle) may be estimated.

### Modification Example 3

According to the above-described embodiments, it is exemplified that the association condition at step S430 is a condition in which the inter-observation-points distance difference is the minimum and the inter-observation-points distance difference is less than a predetermined association threshold. However, the association condition may be a condition indicating that a location of the roadside object point and a location of the second modulation observation point is close. Hence, the association condition at step S430 may be a condition in which the inter-observation-points distance difference is less than the predetermined association threshold. Moreover, the association condition at step S430 may be a condition in which a difference between a distance R to the roadside object and a distance R to the second modulation observation point is less than a predetermined radius distance threshold, and a difference between the horizontal azimuth angle θ of the roadside object point and the horizontal azimuth angle θ of the second modulation observation point is less than a azimuth angle threshold. A difference between the distance R to the roadside object point and the distance R to the second modulation observation point corresponds to radius distance difference, and a difference between the horizontal azimuth angle θ of the roadside object and the horizontal azimuth angle θ of the second modulation observation point corresponds to azimuth angle difference.

### Modification Example 4

According to the above-described embodiments, it is exemplified that the first maximum detection distance is longer than the second maximum detection distance, and the second vertical measurement angle accuracy is higher than the first vertical measurement angle accuracy. However, it may be configured such that the first maximum detection distance is longer than the second maximum detection distance, the radar apparatus 2 excludes a function performed by the first modulation method for detecting the first observation point azimuth angle in the vertical direction, but the radar apparatus 2 includes a function performed by the second modulation method for detecting the second observation point azimuth angle in the vertical direction. In other words, the control apparatus 6 can estimate the vertical axis displacement angle Om even in a case where a vertical measurement angle function by the first modulation method is not provided.

### Modification Example 5

According to the above-described embodiments, it is exemplified that the control apparatus 6 executes an axial displacement adjusting process. However, the radar apparatus 2 may executes the axial displacement adjusting process.

The control apparatus 6 and method thereof disclosed in the present disclosure may be accomplished by a dedicated computer constituted of a processor and a memory programmed to execute one or more functions embodied by computer programs.

Alternatively, the control apparatus 6 and method thereof disclosed in the present disclosure may be accomplished by a dedicated computer provided by a processor configured of one or more dedicated hardware logic circuits. Further, the control apparatus 6 and method thereof disclosed in the present disclosure may be accomplished by one or more dedicated computer where a processor and a memory programmed to execute one or more functions, and a processor configured of one or more hardware logic circuits are combined. Furthermore, the computer programs may be stored, as instruction codes executed by the computer, into a computer readable non-transitory tangible recording media. The method of performing respective functions included in the control apparatus 6 may not necessarily include software, and all functions may be embodied by one or more hardware units.

Multiple functions of a single component in the above-described embodiment may be implemented by multiple components, and a single function of a single component may be implemented by multiple components. Moreover, multiple functions of multiple components may be implemented by a single component, and a single function implemented by multiple components may be implemented by a single component. Further, some of the configurations of the above-described embodiment may be omitted. In addition, at least some of the configurations of the above-described embodiment may be added to or replaced with the configurations of the other embodiments described above.

Other than the above-described control apparatus 6, the present disclosure may be embodied in various manners such as a system including the control apparatus 6 as a constituent, programs causing a computer to serve as the control apparatus 6, a non-transitory tangible recording media such as semiconductor memory device that stores the programs, an axial displacement estimation method and the like.

### Technical Idea Disclosed by the Present Disclosure

### [Item 1]

An axial displacement estimation apparatus (6) that estimates an axial displacement angle (θm) of a radar apparatus (2) mounted on a mobile body (VH0),

wherein
the radar apparatus is configured to transmit and receive first radar waves modulated using a first modulation method to detect a first observation point as a point at which the first radar waves are reflected, thereby repeatedly outputting first observation point information including a first observation point distance as a distance between the radar apparatus and the first observation point, and a first observation point azimuth angle as an azimuth angle along which the first observation point is present; and
the radar apparatus is configured to transmit and receive second radar waves modulated using a second modulation method different from the first modulation method to detect a second observation point as a point at which the second radar waves are reflected, thereby repeatedly outputting second observation point information including a second observation point distance as a distance between the radar apparatus and the second observation point, and a second observation point azimuth angle as an azimuth angle along which the second observation point is present,
the axial displacement estimation apparatus comprising:
a first roadside object extraction unit (S10, S20) configured to extract, among a plurality of the first observation points detected by the radar apparatus, the first observation point as a first roadside object observation point, where radar waves are reflected at roadside objects in a lateral side of a traveling road where the mobile body travels, the roadside objects being arranged at a position higher than the traveling road along a direction where the traveling road extends;
a second roadside object extraction unit (S30) configured to extract, among a plurality of the second observation points detected by the radar apparatus, a second roadside object observation point as the second observation point corresponding to the first roadside object observation point, based on a predetermined association condition indicating that a location of the first roadside object observation point and a location of the second observation point are close; and
an axis displacement angle calculation unit (S40) configured to calculate direction information (β) indicating a direction along which the roadside object extends, based on a distribution of locations of a plurality of the second roadside object observation points extracted by the second roadside object extraction unit, thereby calculating an angle indicating an inclination of a center axis (CA) with respect to a longitudinal direction of the mobile body to be the axial displacement angle, the center axis indicating a direction of the first and second radar waves being transmitted and received by the radar apparatus.

### [Item 2]

The axial displacement estimation apparatus according to item 1,

wherein
a first maximum detection distance as a maximum value of the first observation point distance capable of being detected by the first modulation method, is longer than a second maximum detection distance as a maximum value of the second observation point distance capable of being detected by the second modulation method; and
   a second vertical measurement angle accuracy, which is an accuracy for detecting the second observation point azimuth angle in a vertical direction using the second modulation method, is higher than a first vertical measurement angle accuracy, which is an accuracy for detecting the first observation point azimuth angle in the vertical direction using the first modulation method.

### [Item 3]

The axial displacement estimation apparatus according to item 1,

wherein
a first maximum detection distance as a maximum value of the first observation point distance capable of being detected by the first modulation method, is longer than a second maximum detection distance as a maximum value of the second observation point distance capable of being detected by the second modulation method;
the radar apparatus is configured to exclude a function performed by the first modulation method for detecting the first observation point azimuth angle in the vertical direction; and
the radar apparatus is configured to include a function performed by the second modulation method for detecting the second observation point azimuth angle in the vertical direction.

### [Item 4]

The axial displacement estimation apparatus according to any one of items 1 to 3,

wherein
the axis displacement angle calculation unit is configured to utilize both of a plurality of the second roadside object observation points extracted by the second roadside object extraction unit and the first roadside object observation point which are not associated with the second roadside object observation point, among a plurality of first roadside object observation points extracted by the first roadside object extraction unit, thereby calculating the direction information.

### [Item 5]

The axial displacement estimation apparatus according to any one of items 1 to 3,

wherein
the radar apparatus is configured to output a plurality of pieces of the first observation point information and a plurality of pieces of the second observation point information at a predetermined cycle; and
the axial displacement angle calculation unit is configured to calculate the direction information, based on a distribution of locations of a plurality of the second roadside object observation points acquired in a plurality of the modulation cycles, thereby calculating the axial displacement angle.

### [Item 6]

The axial displacement estimation apparatus according to any one of items 1 to 5,

wherein
the association condition is a condition in which an inter-observation-points distance difference as a distance between the first roadside object observation point and the second observation point is less than a predetermined association threshold.

### [Item 7]

The axial displacement estimation apparatus according to any one of items 1 to 5,

wherein
the association condition is that a second observation point among a plurality of the second observation points satisfies a condition in which an inter-observation-points distance difference as a distance between the first roadside object observation point and the second observation point is the minimum and the inter-observation-points distance difference is less than a predetermined association threshold.

### [Item 8]

The axial displacement estimation apparatus according to any one of items 1 to 5,

wherein
the association condition is that a second observation point satisfies a condition in which a radius distance difference as a difference between the first observation point distance of the first roadside object observation point and the second observation point distance of the second observation point is less than a predetermined radius distance threshold, and an azimuth angle difference as a difference between the first observation point azimuth angle of the first roadside object observation point and the second observation point azimuth angle of the second observation point is less than a predetermined azimuth angle threshold.

### [Item 9]

The axial displacement estimation apparatus according to any one of items 1 to 8,

wherein
the axial displacement angle calculation unit is configured to utilize properties of the roadside object in which a height thereof is constant along a direction where the traveling road extends, to calculate the axial displacement angle.

### [Item 10]

The axial displacement estimation apparatus according to any one of items 1 to 9,

wherein
the axial displacement angle calculation unit is configured to approximate a distribution of locations of a plurality of the roadside object observation points using an approximate straight line, thereby calculating the direction information.

### Conclusion

The present disclosure discloses a technique of improving an axial displacement angle.

One aspect of the present disclosure is an axial displacement estimation apparatus that estimates an axial displacement angle of a radar apparatus mounted on a mobile body and is provided with a first roadside object extraction unit, a second roadside object extraction unit and an axial displacement angle calculation unit.

The radar apparatus is configured to transmit and receive first radar waves modulated using a first modulation method to detect a first observation point as a point at which the first radar waves are reflected, thereby repeatedly outputting first observation point information including a first observation point distance as a distance between the radar apparatus and the first observation point, and a first observation point azimuth angle as an azimuth angle along which the first observation point is present.

The radar apparatus is configured to transmit and receive second radar waves modulated using a second modulation method different from the first modulation method to detect a second observation point as a point at which the second radar waves are reflected, thereby repeatedly outputting second observation point information including a second observation point distance as a distance between the radar apparatus and the second observation point, and a second observation point azimuth angle as an azimuth angle along which the second observation point is present.

The first roadside object extraction unit is configured to extract, among a plurality of the first observation points detected by the radar apparatus, the first observation point as a first roadside object observation point, where radar waves are reflected at roadside objects in a lateral side of a traveling road where the mobile body travels, the roadside objects being arranged at a position higher than the traveling road along a direction where the traveling road extends.

The second roadside object extraction unit is configured to extract, among a plurality of the second observation points detected by the radar apparatus, a second roadside object observation point as the second observation point corresponding to the first roadside object observation point, based on a predetermined association condition indicating that a location of the first roadside object observation point and a location of the second observation point are close.

The axis displacement angle calculation unit is configured to calculate direction information (β) indicating a direction along which the roadside object extends, based on a distribution of locations of a plurality of the second roadside object observation points extracted by the second roadside object extraction unit, thereby calculating an angle indicating an inclination of a center axis with respect to a longitudinal direction of the mobile body to be the axial displacement angle, the center axis indicating a direction of the first and second radar waves being transmitted and received by the radar apparatus.

According to the axial displacement estimation apparatus thus configured, a modulation method suitable for detecting roadside objects arranged along a direction where the traveling road extends, is applied to the first modulation method, a modulation method having a high detection accuracy for detecting locations of the observation points, is applied to the second modulation method, whereby since the direction information indicating a direction where the roadside object extends can be accurately calculated, an estimation accuracy of the axial displacement angle can be improved.

What is claimed is:

1. An axial displacement estimation apparatus that estimates an axial displacement angle of a radar apparatus mounted on a mobile body,
wherein
the radar apparatus is configured to transmit and receive first radar waves modulated using a first modulation method to detect a first observation point as a point at which the first radar waves are reflected, thereby repeatedly outputting first observation point information including a first observation point distance as a distance between the radar apparatus and the first observation point, and a first observation point azimuth angle as an azimuth angle along which the first observation point is present; and
the radar apparatus is configured to transmit and receive second radar waves modulated using a second modulation method different from the first modulation method to detect a second observation point as a point at which the second radar waves are reflected, thereby repeatedly outputting second observation point information including a second observation point distance as a distance between the radar apparatus and the second observation point, and a second observation point azimuth angle as an azimuth angle along which the second observation point is present,
the axial displacement estimation apparatus comprising:
a first roadside object extraction unit configured to extract, among a plurality of the first observation points detected by the radar apparatus, the first observation point as a first roadside object observation point, where radar waves are reflected at roadside objects in a lateral side of a traveling road where the mobile body travels, the roadside objects being arranged at a position higher than the traveling road along a direction where the traveling road extends;
a second roadside object extraction unit configured to extract, among a plurality of the second observation points detected by the radar apparatus, a second roadside object observation point as the second observation point corresponding to the first roadside object observation point, based on a predetermined association condition indicating that a location of the first roadside object observation point and a location of the second observation point are close; and
an axis displacement angle calculation unit configured to calculate direction information indicating a direction along which the roadside object extends, based on a distribution of locations of a plurality of the second roadside object observation points extracted by the second roadside object extraction unit, thereby calculating an angle indicating an inclination of a center axis with respect to a longitudinal direction of the mobile body to be the axial displacement angle, the center axis indicating a direction of the first and second radar waves being transmitted and received by the radar apparatus.

2. The axial displacement estimation apparatus according to claim 1,
wherein
a first maximum detection distance as a maximum value of the first observation point distance capable of being detected by the first modulation method is longer than a second maximum detection distance as a maximum value of the second observation point distance capable of being detected by the second modulation method; and
a second vertical measurement angle accuracy, which is an accuracy for detecting the second observation point azimuth angle in a vertical direction using the second modulation method, is higher than a first vertical measurement angle accuracy, which is an accuracy for detecting the first observation point azimuth angle in the vertical direction using the first modulation method.

3. The axial displacement estimation apparatus according to claim 1,
wherein
a first maximum detection distance as a maximum value of the first observation point distance capable of being detected by the first modulation method is longer than a second maximum detection distance as a maximum value of the second observation point distance capable of being detected by the second modulation method;
the radar apparatus is configured to exclude a function performed by the first modulation method for detecting the first observation point azimuth angle in the vertical direction; and
the radar apparatus is configured to include a function performed by the second modulation method for detecting the second observation point azimuth angle in the vertical direction.

4. The axial displacement estimation apparatus according to claim 1,
wherein
the axis displacement angle calculation unit is configured to utilize both of a plurality of the second roadside object observation points extracted by the second roadside object extraction unit and the first roadside object observation point which are not associated with the second roadside object observation point, among a plurality of first roadside object observation points extracted by the first roadside object extraction unit, thereby calculating the direction information.

5. The axial displacement estimation apparatus according to claim 1,
wherein
the radar apparatus is configured to output a plurality of pieces of the first observation point information and a plurality of pieces of the second observation point information at a predetermined cycle; and
the axial displacement angle calculation unit is configured to calculate the direction information, based on a distribution of locations of a plurality of the second roadside object observation points acquired in a plurality of the modulation cycles, thereby calculating the axial displacement angle.

6. The axial displacement estimation apparatus according to claim 1,
wherein
the association condition is a condition in which an inter-observation-points distance difference as a distance between the first roadside object observation point and the second observation point is less than a predetermined association threshold.

7. The axial displacement estimation apparatus according to claim 1,
wherein
the association condition is that a second observation point among a plurality of the second observation points satisfies a condition in which an inter-observation-points distance difference as a distance between the first roadside object observation point and the second observation point is the minimum and the inter-observation-points distance difference is less than a predetermined association threshold.

8. The axial displacement estimation apparatus according to claim 1,
wherein
the association condition is that a second observation point satisfies a condition in which a radius distance difference as a difference between the first observation point distance of the first roadside object observation point and the second observation point distance of the second observation point is less than a predetermined radius distance threshold, and an azimuth angle difference as a difference between the first observation point azimuth angle of the first roadside object observation point and the second observation point azimuth angle of the second observation point is less than a predetermined azimuth angle threshold.

9. The axial displacement estimation apparatus according to claim 1,
wherein
the axial displacement angle calculation unit is configured to utilize properties of the roadside object in which a height thereof is constant along a direction where the traveling road extends, to calculate the axial displacement angle.

10. The axial displacement estimation apparatus according to claim 1,
wherein
the axial displacement angle calculation unit is configured to approximate a distribution of locations of a plurality of the roadside object observation points using an approximate straight line, thereby calculating the direction information.
